(19) United States
(12) Patent Application Publication
(10) Pub. No.: US 2007/0026204 A1
(43) Pub. Date: Feb. 1, 2007

(54) Embedded watermark

(76) Inventors: Michael Patrick Caulley, Redwood City, CA (US); Phieu Luong, San Francisco, CA (US)

Correspondence Address: MCDERMOTT WILL & EMERY LLP, 600 13TH STREET, N.W., WASHINGTON, DC, 20005-3096, US

(21) Appl. No.: 11/193,230

(22) Filed: Jul. 28, 2005

(51) Int. Cl. G03G 7/00

(52) U.S. Cl. 428/195.1

(57) ABSTRACT

An anti-counterfeit image feature for laminated plastic cards used for identification and transaction having the appearance of a watermark.

### FIELD OF THE INVENTION

The present invention relates to an anti-counterfeiting feature having a watermark-like appearance in a laminated card, where such a card is used as an identification card, credential, access card, transaction card, ticket, credit card, cash card, debit card, etc.

### BACKGROUND OF THE INVENTION

Identification and transaction cards are typically made from a stack of laminated polyvinyl chloride (PVC) layers. These cards may include one or more security (i.e., anti-counterfeiting) features. The anti-counterfeiting features are generally a form of print (right-reading or reverse reading) or applied matter (i.e., a holographic foil) placed on a layer or an image embossed or debossed, and either single or dual-die stamped into a layer. Identification or transaction cards may include one or more of the following methods.

Embossing produces an image (graphic or alphanumeric text) that is raised above the surface of the layer. With debossing, the image is pressed into the layer and appears below the surface. Blind embossing and blind debossing are the processes of embossing or debossing, respectively, an image that is the same color as the layer.

Another method is to place specially marked aluminum foils (holograms) on an outer layer. One variation laminates (using heat and pressure) the specially marked aluminum foil in place while another variation uses adhesive to attach the specially marked aluminum foil to the plastic layer. Adhesive is typically required where printing is underneath the foil.

Another method is the use of Multi-Layered Film to create Hot-Stamping Foil. Generally, it starts with a 20-Micron Polyester carrier coated with a waxy release layer, then a special coating with the top coating layer to impart resistance to whatever hostile environment the foil will be exposed to. This coating protects everything beneath it. Beneath the top coating is the embossable coating that receives the embossing of image. The material is then metallized by vacuum deposition of aluminum. Hot-stamping the aluminum foil can deform (deboss) the plastic layer, although that is not the normal intent as the foil color is also diminished by the heat and pressure. Clear holograms lack the metal foil.

Another method is using a holographic pouch to hold the identification or transaction card. First, a hologram image is embossed on transparent hologram security laminate. Then the identification or transaction card is sealed inside the pouch. A weak-intensity holographic image indicates solvent tampering. A destroyed image indicates alteration. An absent image indicates a counterfeit card. An optional destruct feature occurs during an attempt to remove the laminate—even if the counterfeiter tries to reposition the laminate on another card or in its original place.

Print based anti-counterfeiting methods rely on the difficulty of detecting the print, reproducing the print, or a combination of both. Ultraviolet inks are invisible to the unaided eye and are only visible only under ultraviolet light. Microfine printing is very small, on the order of 2 to 4 points. Guilloche patterns are complex interwoven lines based on mathematical formula that are difficult to reproduce. Color-shifting inks appear as different colors according to angle of reflected lighting the viewer perceives. DNA Matrix security inks contain ascertainable quantities of DNA in the ink, allowing indisputable verification of the origin of the ink.

Generally the print methods are directly on the outer plastic layer. However, to avoid wear and counterfeiting of the print, a thin clear layer is often laminated or glued over the print layer.

A problem with these methods is that the anti-counterfeit feature lies on an upper layer of the card that is easier to access and transfer for counterfeiting purposes. Also the feature is subject to environmental degradation.

Embedded security features, such as an embedded hologram, refer to placement of the security feature on a layer of plastic, after which another layer of plastic, either clear or colored, is placed over the layer containing the security feature.

Efforts to embed a hologram on an inner layer have met with limited success. Too much heat during lamination will dull the holographic image, and the hologram looses its sparkle. Conversely, lowering the heat in lamination to save the hologram is usually not hot enough to bond the plastic layers together. The plastic must be heated enough to stick all the layers together but not dull the sparkle of the hologram.

While watermarks in paper help lessen counterfeit opportunity in paper records, similar technology in plastic laminate layers has been elusive. Past efforts to place a counterfeit secure watermark-like feature in plastic inner layers were defeated by the temperature and pressure exerted over time on the inner layers by subsequent lamination processes that marred the watermark-like image.

Recent advancements in plastics has yielded a microporous silica-filled polyethylene (polyolefin) layer, such as one known as TESLIN® by PPG Industries, Inc. of Pittsburgh, Pa. In its various compositions, TESLIN® is printable by both inkjet and laser printers, and retains the printing under lamination. Consequently, TESLIN® is popular in the identification and transaction card industry. However, due to the low cost of TESLIN®, and the ease and low cost of both reproduction and printing, printed TESLIN® cards are subject to counterfeiting. Another method is needed to deter and detect counterfeit identification and transaction cards.

The present invention overcomes these past failures to create a plastic counterfeit-secure watermark-like image on an identification or transaction card.

### SUMMARY OF THE INVENTION

The present invention provides for the appearance of a watermark-like image in laminated plastic cards. The technology behind this watermark-like image has the advantage of being virtually counterfeit-proof since the watermark-like image is integrated into the base layers of the card, yet detectably visible for deterrence and detection of counterfeiting efforts. The present invention uses a microporous silica-filled polyethylene layer (i.e., TESLIN® by PPG Industries, Inc. of Pittsburgh, Pa) that may be deformed (i.e., stamped by embossing or debossing) creating an image that appears like a watermark through subsequently laminated layers.

Unlike PVC, the microporous silica-filled polyethylene (a.k.a. polyolefin) layer may be embossed or debossed to create an image and subsequently laminated under defined parameters without marring the image on the polyolefin layer. Furthermore, the image may be created with stamped holographic foil by either a cold or hot stamp process.

### BRIEF DESCRIPTION OF THE DRAWINGS

FIG. 1 shows a cross-sectional view of one embodiment of the present invention showing the watermark-like image as if embossed, debossed or stamped with holographic foil on a microporous silica-filled polyethylene (i.e., Teslin®) layer between two white plastic layers.

FIG. 2 shows an exploded perspective view of the preferred embodiment of the present invention showing the watermark-like image as if embossed, debossed, or stamped with holographic foil on a microporous silica-filled polyethylene layer between the variably opaque white laminated plastic layers on either side.

FIG. 3 shows an exploded perspective view of the present invention showing the watermark-like image as if embossed, debossed or stamped with holographic foil on a microporous silica-filled polyethylene layer and showing through the successive laminated layers on either side of the watermark-like image.

### DETAILED DESCRIPTION AND PREFERRED EMBODIMENTS

Reference will now be made to embodiments of the present invention, examples of which are illustrated in the accompanying drawings. These drawings illustrate the present invention and the various steps of the process invention intended to form the desired product and the appearance of the intermediate pieces formed during the process.

While certain embodiments of the present invention might prefer an overt appearance of the image for counterfeiting deterrence, other embodiments of the watermark-like image would be covert to make detection of the watermark-like image to counterfeiters more difficult. The visibility or covertness of the watermark-image is determined by use of plastic layers in different configurations of opacity and thickness.

In the preferred embodiment, the present invention embosses or debosses the watermark-mark image on a microporous silica-filled polyethylene layer that is then laminated between two variably opaque white plastic layers to create a laminate stack. Alternatively, a holographic foil might be stamped onto the microporous silica-filled polyethylene layer in lieu of an embossed or debossed image.

This laminate stack is then further laminated within subsequent variably opaque clear plastic layers. Layers of clear plastic may be placed over the variably opaque layers for wear protection. The watermark-like image appears covertly in the variably opaque white plastic layers behind the outer variably printed layers.

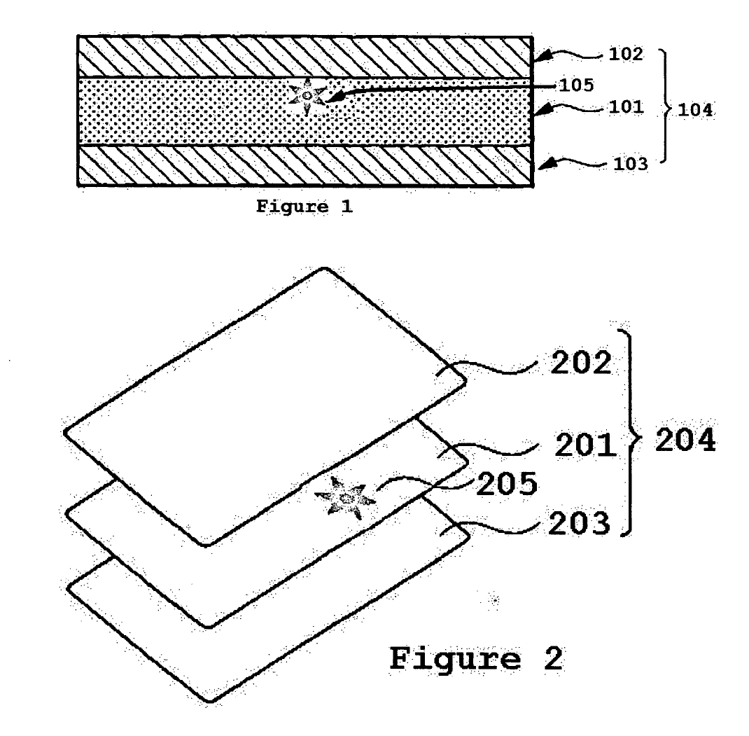

FIG. 1 shows a cross-sectional view of the present counterfeit-secure feature invention 104 showing the three plastic layers 101, 102, and 103. The watermark-like image 105 is represented here by a single graphic on the microporous silica-filled polyethylene layer, 101 as laminated between the two variably opaque white plastic layers 102 and 103.

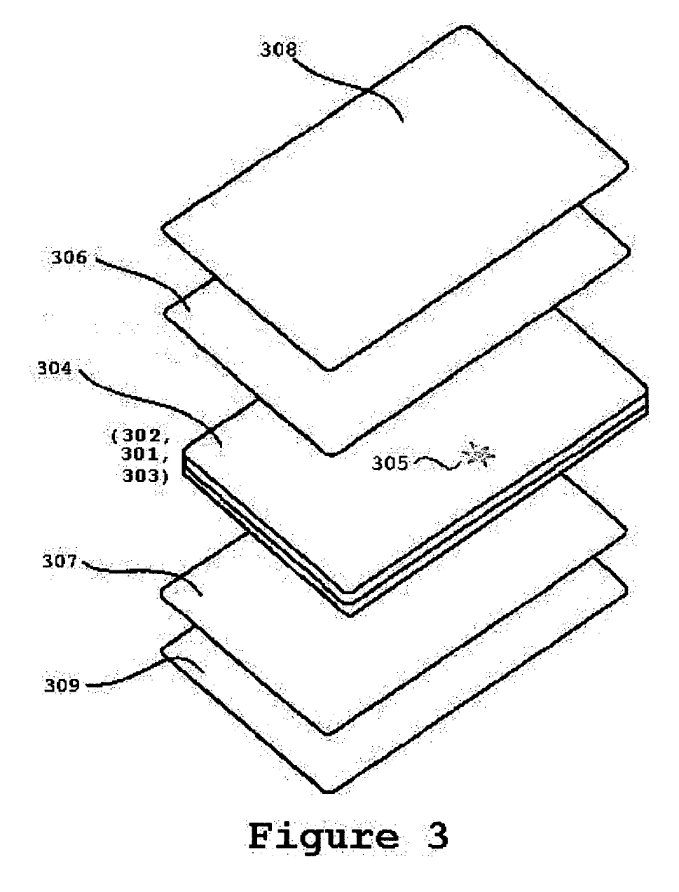

FIG. 2 shows an exploded perspective view of the present counterfeit-secure feature invention 204. The watermark-like image 205 shows as if embossed, debossed, or stamped with holographic foil on the microporous silica-filled polyethylene layer, 201. The microporous silica-filled polyethylene layer 201 containing the watermark-like image 205 is then laminated between the two variably opaque white plastic layers 202 and 203.

FIG. 3 shows an exploded perspective view of the present counterfeit-secure feature invention 304 readied for use. The watermark-like image 305 shows as if embossed, debossed, or stamped with holographic foil on the microporous silica-filled polyethylene layer 301. The microporous silica-filled polyethylene layer 301 containing the watermark-like image 305 is then laminated between two variably opaque white plastic layers 302 and 303. Layers 306 and 307 are subsequently laminated over layers 302 and 303 respectively. Clear plastic layers 308 and 309 are then laminated over layers 306 and 307 respectively to provide additional counterfeiting deterrence and environmental protection for the sub-layers.

In lieu of the being the center layer as shown, the microporous silica-filled polyethylene layer 301 containing the watermark-like image 305 may be eccentrically laminated into the subsequent laminate layers. Layer 302 or 303 is then absent and the watermark-like image 305 lies closer to laminate layer 306 or 307 than to the other laminate layer.

Furthermore, layers 302 or 303 may be clear or non-white to change the opacity to the watermark. Similarly, layers 306 or 307 may be substantially clear or variably opaque. Additionally, layers 306 or 307 may have custom printing and possibly other counterfeit-secure features.

In yet another embodiment, a build-up of substantially clear layers, i.e., 302, 303, 306, 307, 308 and 309, plus others, in lieu of the variably opaque white plastic layers would differently mask the watermark-image by the cumulative opacity of the substantially clear layers.

The watermark-like image 105, 205 and 305 in the drawings is represented by a single graphic image. In use the watermark-like image may be one or more graphic images, text, or a combination of graphic images and text. Furthermore, those skilled in the art will appreciate that the simple geometric shapes for the plastic layers are merely representative for simplicity and clarity in the drawings. In fact, a wide variety of complexity in configuration in layers and sizes can be successfully created with the present invention.

As used in this patent, the term “variably opaque” refers to the opacity of different stocks of laminate layers. The variably opaque layers may be transparent, substantially clear, colored plastic of different colors for opacity, or printed for opacity.

Typically, but not required of the present invention, is that the variably opaque plastic layers, regardless of clarity or color, are composed of polyvinyl chloride or a polyvinyl chloride-polyester blend. Those skilled in the art will appreciate that other materials commonly used for a laminated card are also suitable. These would not exclusively include plastics such as polyester, polyethylene (and its blends and variations), polycarbonate, acrylonitrile-butadiene-styrene and polyethylene tetraphtalate.

Those skilled in the art will further appreciate that while successful lamination of the watermark-like image feature requires specific parameters of time, pressure, and temperature, the precise values will vary according to the material, process, and image. Cold embossing of TESLIN® is not generally as effective as thermal embossing. Temperatures in the range of 200-270° F. or higher may be required. Dwell times and pressure requirements will be a function of the graphics, the degree of embossing, debossing or stamping desired, and the hardware.

In addition, those skilled in the art will appreciate that the dual anti-counterfeiting advantage of an embedded watermark-like image feature. First, by being embedded, the watermark-like image is much less accessible to tampering, and any tampering is more likely to destroy the card, or be evident to the naked eye. Second, by virtue of being embossed, debossed or stamped to an inner plastic layer, even high resolution copying cannot accurately reproduce the image to its true watermark-like appearance.

Furthermore, those skilled in the art will appreciate that compound watermark-like image layers with one or more images on each layer are possible by the bonding of multiple layers of microporous silica-filled polyethylene layers to other layers of microporous silica-filled polyethylene. Such bonding is possible with adhesive or layers of other plastics as discussed above interposed between the multiple layers of microporous silica-filled polyethylene layers.

1. A method for creating a watermark-like image feature in a laminated plastic card comprising:
deforming a re-form-resistant plastic layer to create a watermark-like image layer;
laminating said watermark-like image layer to a first variably opaque plastic layer and a second variably opaque plastic layer;
then further laminating said watermark-like image layer to a third variably opaque plastic layer and a fourth variably opaque plastic layer.

2. The method for creating a watermark-like image feature in a laminated plastic card of claim 1 wherein:
Said deforming comprises embossing, debossing, or hot-stamping.

3. A method for creating a watermark-like image feature in a laminated plastic card comprising:
deforming at least two re-form-resistant plastic layers to create at least two watermark-like image layers;
bonding together the watermark-like image layers to create a compound watermark-like image layer;
then laminating said watermark-like image layer to a first variably opaque plastic layer and a second variably opaque plastic layer;
then further laminating said compound watermark-like image layer to a third variably opaque plastic layer and a fourth variably opaque plastic layer.

4. A watermark-like image feature in a laminated plastic card comprising:
an image applied to a re-form-resistant plastic layer;
a first plastic laminate layer;
a second plastic laminate layer;
a third plastic laminate layer; and
a fourth plastic laminate layer.

5. The watermark-like image feature in a laminated plastic card of claim 4 wherein said microporous silica-filled polyethylene layer lies between said first plastic laminate layer and said second plastic laminate layer.

6. The watermark-like image feature in a laminated plastic card of claim 4 wherein said microporous silica-filled polyethylene layer lies between said first plastic laminate layer and said third plastic laminate layer.

7. The watermark-like image feature in a laminated plastic card of claim 4 wherein said microporous silica-filled polyethylene layer lies between said first plastic laminate layer and said fourth plastic laminate layer.

8. The watermark-like image feature in a laminated plastic card of claim 4 wherein at least one of said first plastic laminate layer and said second plastic laminate layer and said third plastic laminate layer and said fourth plastic laminate layer comprises white polyvinyl chloride.

9. The watermark-like image feature in a laminated plastic card of claim 4 wherein at least one of said first plastic laminate layer and said second plastic laminate layer and said third plastic laminate layer and said fourth plastic laminate layer comprises variably opaque polyvinyl chloride.

10. The watermark-like image feature in a laminated plastic card of claim 4 wherein at least one of said first plastic laminate layer and said second plastic laminate layer and said third plastic laminate layer and said fourth plastic laminate layer comprises substantially clear polyvinyl chloride.

11. The watermark-like image feature in a laminated plastic card of claim 4 wherein at least one of said first plastic laminate layer and said second plastic laminate layer and said third plastic laminate layer and said fourth plastic laminate layer comprises microporous silica-filled polyethylene.

12. The watermark-like image feature in a laminated plastic card of claim 4 wherein at least one of said first plastic laminate layer and said second plastic laminate layer and said third plastic laminate layer and said fourth plastic laminate layer comprises polyethylene.

13. The watermark-like image feature in a laminated plastic card of claim 4 wherein at least one of said first plastic laminate layer and said second plastic laminate layer and said third plastic laminate layer and said fourth plastic laminate layer comprises polycarbonate.

14. The watermark-like image feature in a laminated plastic card of claim 4 wherein at least one of said first plastic laminate layer and said second plastic laminate layer and said third plastic laminate layer and said fourth plastic laminate layer comprises acrylonitrile-butadiene-styrene.

15. The watermark-like image feature in a laminated plastic card of claim 4 wherein at least one of said first plastic laminate layer and said second plastic laminate layer and said third plastic laminate layer and said fourth plastic laminate layer comprises polyethylene tetraphtalate.

16. A watermark-like image feature in a laminated plastic card of claim 4 further comprising at least a second re-form-resistant plastic layer deformed and interposed between said first variably opaque plastic layer and said second variably opaque plastic layer and bonded to the re-form-resistant plastic layer of claim 4.

17. The watermark-like image feature in a laminated plastic card of claim 4 wherein said image is embossed into said microporous silica-filled polyethylene layer.

18. The watermark-like image feature in a laminated plastic card of claim 4 wherein said image is debossed into said microporous silica-filled polyethylene layer.

19. The. watermark-like image feature in a laminated plastic card of claim 4 wherein said image is stamped into aluminum foil and laminated to said microporous silica-filled polyethylene layer.

20. The watermark-like image feature in a laminated plastic card of claim 4 wherein said image is stamped into aluminum foil by the application of pressure to said microporous silica-filled polyethylene layer.

21. The watermark-like image feature in a laminated plastic card of claim 4 further comprising a hologram.

22. The method according to claim 1 wherein said re-form-resistant plastic comprises microporous silicon-filled polyethylene.

23. The method according to claim 3 wherein said re-form-resistant plastic comprises microporous silicon-filled polyethylene.

24. The method according to claim 3 wherein said deforming comprises embossing, debossing, or hot-stamping.

25. The method according to claim 4 wherein said re-form-resistant plastic comprises microporous silicon-filled polyethylene.

26. The method according to claim 16 wherein said re-form-resistant plastic comprises microporous silicon-filled polyethylene.

27. A method for creating a watermark-like image feature in a plastic card comprising:
deforming a re-form-resistant plastic layer to create a watermark-like image layer;
bonding said re-form resistant plastic layer to at least one plastic layer.

28. The method according to claim 27 wherein said re-form-resistant plastic comprises microporous silicon-filled polyethylene.

29. The method according to claim 27 wherein said deforming comprises embossing or debossing.

30. The method according to claim 29 wherein said embossing or debossing further comprises using heat.

31. The method according to claim 27 wherein said deforming comprises hot-stamping.

32. The method according to claim 31 wherein said hot stamping comprises the use of a metal foil.

33. The method according to claim 31 wherein said hot stamping comprises the use of a non-metal foil.

34. The method according to claim 27 wherein said bonding comprises lamination.

35. The method according to claim 34 wherein said lamination does not alter the shape or clarity of said image.

36. The method according to claim 27 wherein said at least one plastic layer is substantially clear.

37. The method according to claim 27 wherein said at least one plastic layer is substantially variably opaque.

38. A feature in a plastic card comprising:
an image formed in a re-form-resistant plastic layer; and,
at least one plastic layer bonded to said re-form-resistant plastic layer.

39. The feature according to claim 38 wherein said re-form-resistant plastic comprises microporous silicon-filled polyethylene.

40. The feature according to claim 38 wherein said image is formed using an embossing or debossing process.

41. The feature according to claim 38 wherein said image is embossed or debossed using heat.

42. The feature according to claim 38 wherein said at least one plastic layer is selected from the group consisting of polyvinyl chloride, microporous silica-filled polyethylene, polyethylene, polycarbonate, acrylonitrile-butadiene-styrene, polyethylene tetraphthalate, and polyester.

43. The feature according to claim 38 wherein said at least one plastic layer is substantially variably opaque.

44. The feature according to claim 38 wherein said at least one plastic layer is substantially clear.

45. The feature according to claim 38 wherein said at least one plastic layer is bonded to said re-form-resistant plastic layer using a lamination process.

46. The feature according to claim 45 wherein said lamination does not alter the shape or clarity of said image.

47. The feature according to claim 38 further comprising a second plastic layer, said second plastic layer bonded to said at least one plastic layer.

48. The feature according to claim 47 wherein said second plastic layer is bonded to said at least one plastic layer using lamination.

49. The feature according to claim 38 wherein said image is formed using a hot-stamping process.

50. The feature according to claim 48 wherein said lamination does not alter the shape or clarity of said image.
